(19) United States
(12) Patent Application Publication
(10) Pub. No.: US 2010/0027182 A1
(43) Pub. Date: Feb. 4, 2010

(54) DEVICE FOR PROTECTING AN ELECTRICAL INSTALLATION, CORRESPONDING METHOD AND USE

(76) Inventors: Hervé Lindeperg, Strasbourg (FR); Gérard Serrie, Cleutat (FR); Louis Bernard Claude Maurice, Saint Cyr au Mont d'Or (FR)

Correspondence Address: BARNES & THORNBURG LLP, Suite 1150, 3343 Peachtree Road, N.E., Atlanta, GA, 30326-1428, US

(21) Appl. No.: 11/720,660

(22) PCT Filed: Dec. 2, 2005
(86) PCT No.: PCT/FR2005/003001

§ 371 Date: Aug. 25, 2009

(30) Foreign Application Priority Data
Dec. 3, 2004 (FR) 0412881

(51) Int. Cl. H02H 1/00; H01H 69/02

(52) U.S. Cl. 361/131; 29/622

(57) ABSTRACT

A protection device for protecting an electrical installation, which protection device is designed to be connected in parallel with the electrical installation and includes at least two electrically conductive contact members (3, 4) that are suitable for going from a closed position to an open position when a current (I) of magnitude greater than a predetermined threshold value passes through the protection device (1), said protection device being characterized in that, in the closed position, the contact members are separated from each other by a potentially insulating piece (15), thereby forming a spark gap (E) for protecting from voltage surges between the contact members (3, 4). The invention also relates to apparatus for protecting electrical installations.

### PRIORITY CLAIM

This patent application is a U.S. National Phase of International Application No. PCT/FR2005/003001, filed Dec. 2, 2005, which claims priority to French Patent Application No. 0412881, filed Dec. 3, 2004, the disclosures of which are incorporated herein by reference in their entirety.

### TECHNICAL FIELD

The present invention relates to the general technical field of devices for protecting electrical equipment or electrical installations from electrical disturbances such as transient voltage surges due to lightning strikes.

The present invention relates more particularly to a protection device for protecting an electrical installation, which protection device is designed to be connected in parallel with the electrical installation and includes at least two electrically conductive contact members that are suitable for going from a closed position to an open position when a current of magnitude greater than a predetermined threshold value passes through the protection device.

The present invention also relates to a method of manufacturing a protection device for protecting an electrical installation, which protection device includes at least two electrically conductive contact members that are suitable for going from a closed position to an open position when a current of magnitude greater than a predetermined threshold value passes through the protection device.

The present invention finally relates to a novel use of current-surge protection devices.

### BACKGROUND OF THE ART

It is known that, in order to protect an electrical installation, it is possible to use a protection device, of the spark-gap lightning arrester type, for protecting from voltage surges, connected in series with a protection device, of the circuit-breaker cutout switch type, for protecting from current surges. The circuit-breaker then makes it possible to isolate the lightning arrester in the event of failure thereof, while also preventing the other general interrupter members of the electrical installation from opening, so as to guarantee continuity in the provision of the service of supplying electrical power.

Although such circuit configurations make it possible to optimize operation of the electrical installation while also guaranteeing that it withstands voltage surges, they suffer from non-negligible drawbacks related, in particular, to the complexity of selecting the various components. It is very difficult, with known circuit configurations, to control and to optimize the level of protection of the electrical installation.

In particular, in order to achieve the desired level of protection, such circuit configurations generally involve taking account not only of the level of protection of the lightning arrester but also of the impedance of the circuit-breaker. In addition, the lightning arrester and the circuit-breaker are sometimes situated remote from each other and the impedance of the conductors interconnecting them is often difficult or even impossible to calculate accurately, which can give rise to errors and to a wrong estimation of the real level of protection given to the electrical installation.

In order to mitigate those drawbacks, it has already been imagined to incorporate the circuit-breaker and the arrester in the same housing, thereby making it possible to limit the risk of error, by not allowing the operator the possibility of choosing which type of circuit-breaker to associate with a given lightning arrester. Such devices, which are laboratory tested in the configuration in which they are to be used, also make it possible to guarantee a certain overall level of protection.

In spite of the above-mentioned advantages, those devices suffer from drawbacks. In particular, implementing them requires the structure of the lightning arrester and/or the structure of the circuit-breaker to be modified, often fundamentally, in order to couple them together.

Furthermore, putting a lightning arrester and a circuit-breaker together in the same housing generally leads the manufacturer to increase dimensions compared with the conventional housings used when the two components are implemented separately, thereby giving rise to problems of lack of compactness.

### SUMMARY OF THE INVENTION

The present invention provides a protection device for protecting an electrical installation that does not suffer from the above-mentioned drawbacks and that is suitable for being obtained using standard components, without fundamentally modifying the structure of a known protection device, of the circuit-breaker type.

A feature of the present invention is to provide a novel protection device that makes it possible to guarantee a certain level of protection for the electrical installation, while also minimizing the number of components necessary for implementing it.

Another feature of the present invention is to provide a novel protection device that is particularly compact and robust.

Another feature of the present invention is to provide a novel protection device that is suitable for offering, as alternatives, a plurality of levels of protection for the electrical installation.

Another feature of the present invention is to provide a novel protection device that is suitable for being isolated effectively from the electrical installation when it is subjected to a current surge.

Another feature of the present invention is to provide a novel protection device that is particularly easy to install.

Another feature of the present invention is to provide a novel protection device whose operating state is easy to monitor.

Another feature of the present invention are also to provide a novel method of improving a protection device for protecting an electrical installation that makes it possible, simply and by means of standard components, to improve the performance of the device.

Another feature of the present invention is to provide a novel method of improving a protection device that makes it possible to improve the functionality of said protection device.

Another feature of the present invention is to provide a novel method of improving a protection device that makes it possible to improve control over the level of protection offered by the device.

Features of the present invention are also to provide a novel use of a protection device for protecting from current surges that makes it possible to impart additional protection functions to said protection device.

The feature assigned to the invention are achieved by means of a protection device for protecting an electrical installation, which protection device is designed to be connected in parallel with the electrical installation and includes at least two electrically conductive contact members that are suitable for going from a closed position to an open position when a current of magnitude greater than a predetermined threshold value passes through the protection device, said protection device being characterized in that, in the closed position, the contact members are separated from each other by a potentially insulating piece, thereby forming a spark gap for protecting from voltage surges between the contact members.

The feature assigned to the invention are also achieved by means of a method of manufacturing a protection device for protecting an electrical installation, which protection device includes at least two electrically conductive contact members that are suitable for going from a closed position to an open position when a current of magnitude greater than a predetermined threshold value passes through the protection device, said method being characterized in that it includes a mounting step consisting in mounting a potentially insulating piece between the contact members, so that, in the closed position, the contact members are separated from each other by said potentially insulating piece, thereby forming a spark gap for protecting from voltage surges between the contact members.

The feature assigned to the invention are also achieved by the use of a current surge protection device as a protection device for protecting from voltage surges by interposing a potentially insulating piece between the contact members of the current surge protection device so as to form a spark gap for protecting from voltage surges between said contact members.

### BRIEF DESCRIPTION OF THE DRAWINGS

Other features and advantages of the invention appear in more detail on reading the following description and on examining the accompanying drawing which is given merely by way of non-limiting and illustrative example, and in which:

FIG. 1 is a simplified electrical circuit diagram showing the principle of the protection device of an exemplary embodiment of the present invention in a first position that is said to be “closed”;

FIG. 2 is a simplified electrical circuit diagram showing the protection device of the embodiment shown in FIG. 1, in its open position;

FIG. 3 is a detailed diagrammatic view of the protection device of the embodiment in its closed position; and

FIG. 4 is a detailed diagrammatic view of the protection device of the embodiment in its open position.

### DETAILED DESCRIPTION OF THE PREFERRED EMBODIMENTS

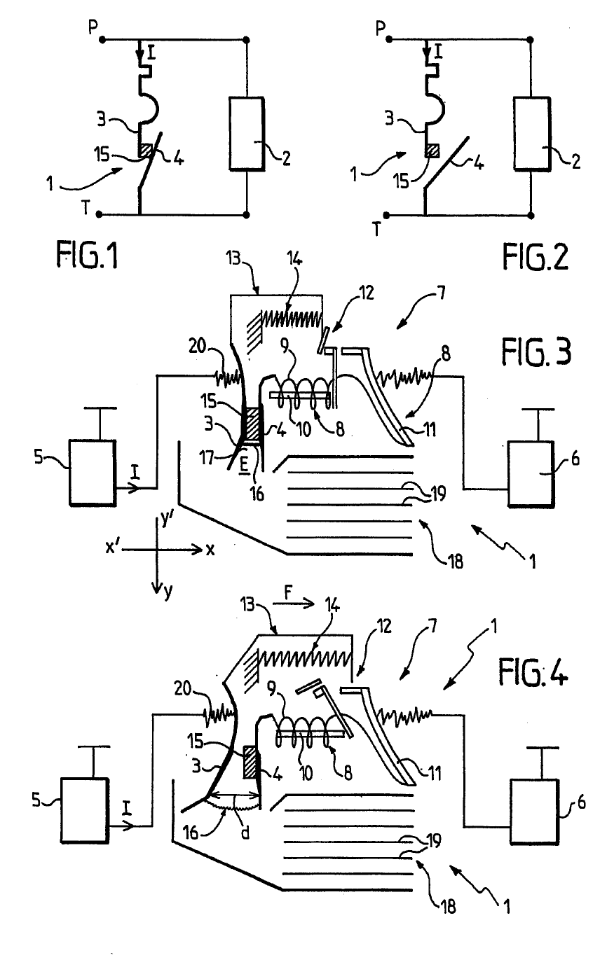

The protection device 1 of the invention is shown in FIGS. 1 to 4. It is designed to be connected in parallel relative to an electrical installation 2 with a view to protecting said electrical installation.

The expression “electrical installation” refers herein to any type of apparatus or network that is suitable for being powered by means of electricity.

The protection device 1 of the invention is advantageously designed to be disposed between a phase P of the installation 2 to be protected and ground T. Without going beyond the ambit of the invention, instead of the protection device 1 being connected in parallel between a phase P and ground T, it is also possible for it to be connected between neutral and ground, between a phase and neutral, or indeed between two phases (for differential protection).

The protection device 1 of the invention is advantageously connected to the electrical installation 2 by wiring, via connection terminals 5, 6.

In accordance with an essential characteristic of the invention, the protection device 1 has at least two electrically conductive and preferably metal contact members 3, 4 that are suitable for taking up at least two distinct positions, and in particular for going from a “closed” position to an “open” position when a current I of magnitude greater than a predetermined threshold value passes through the protection device 1.

The closed position, shown in FIG. 1, corresponds to the operating position of the protection device 1 in which said protection device is connected to the electrical installation 2 and is capable of protecting it.

The open position, shown in FIG. 2, corresponds to an out-of-service state, in which the protection device 1 is no longer connected to the electrical installation 2 and is thus no longer capable of protecting it. Disconnection takes place by moving the contact members 3, 4 apart so as to increase the isolation distance between them, in the manner of a circuit-breaker.

Preferably, the protection device 1 includes at least one moving contact member 3 suitable for being moved between the above-mentioned closed position and the above-mentioned open position, and connected, preferably directly, to one of the connection terminals 5, e.g. by means of a flexible connector 20 allowing it to move. The protection device 1 also preferably includes a fixed contact member 4 which, during a changeover from the closed position to the open position, advantageously remains stationary.

However, it is possible to replace the fixed contact member 4 with a moving contact member without going beyond the ambit of the invention.

Advantageously, the protection device 1 includes a trigger mechanism 7 that is sensitive to the magnitude of the current I passing through it and that is suitable for triggering opening of the contact members 3, 4 when the current I exceeds the above-mentioned predetermined threshold value.

To this end, the trigger mechanism 7 includes detector means 8 for detecting current surges, which detector means are disposed in series between one of the contact members, e.g. the fixed contact member 4, and one of the connection terminals 6, so as to pass substantially the same current as the current that is passed by the protection device 1. The detector means 8 can advantageously include a bimetallic strip 11 and/or an induction coil 9, wound around a solenoid plunger 10. Since such means are used conventionally in circuit-breakers and are well known to the person skilled in the art, they are not described in any further detail below.

The detector means 8 are preferably drivingly connected to a drive mechanism 12 suitable for causing the moving contact member 3 to go from the closed position to the open position when a current surge is detected by the detector means 8. Thus, when a current I of magnitude exceeding a predetermined threshold value passes through the bimetallic strip 11 and through the coil 9, two phenomena can take place as alternatives or simultaneously.

In a first situation, the thermal effects due to the passing of a current I of high magnitude cause the bimetallic strip 11 to bend, thereby in turn actuating or triggering the drive mechanism 12 (FIG. 4).

In a second situation that can take place as an alternative or simultaneously with the above-mentioned first situation, the magnetic effects due to the current I passing through the induction coil 9 cause the solenoid plunger 10 to move, thereby in turn actuating the drive mechanism 12.

The drive mechanism 12 advantageously includes a moving support 12 that is secured to the moving contact member 3 and that is held in the closed position shown in FIG. 3 under bias from resilient return means 14 of the spring type. When a voltage surge occurs, the drive mechanism 12 is triggered, the moving support 13 is released and moves, e.g. in translation, under drive from the resilient return force F exerted by the resilient means 14, driving with it the moving contact member 3 that moves the fixed contact member 4 over a predetermined isolation distance d.

In accordance with an essential characteristic of the protection device 1 of the invention, when the contact members 3, 4 are in their closed position, they are separated from each other by a potentially insulating piece 15.

The piece 15 is thus advantageously interposed between the contact members 3, 4 so that, when they are in the closed position, the contact members 3, 4 come into abutment and into physical contact with the piece 15. The function of the piece 15 is thus to hold the contact members 3, 4 apart so that, in the closed position shown in FIG. 3, the contact members 3, 4 are separated by a gap, thus forming a spark gap E for protecting from voltage surges between the contact members 3, 4. The term “spark gap” E is used herein to designate the dielectric medium 17 which, in the closed position or in the open position, separates the contact members 3, 4, and in which an electric arc 16 can be struck, said electric ark 16 corresponding to the dielectric medium 17 being ionized. The width of the gap and, in particular of the spark gap E is thus advantageously predetermined by the width of the piece 15 so that, in the event of a voltage surge exceeding a predetermined value, an electric arc 16 is struck between the contact members 3, 4 and thus passes the voltage surge current to ground.

The expression “potentially insulating” is used to designate the property of certain materials which, when their maximum current-passing capacity has been reached, are suitable for going from a conductive state to an insulating state in which, in the manner of an insulator, they limit passage of current. Such materials include conventional dielectric materials, such as ceramics, and also materials based on metal oxide, e.g. zinc oxide, such as semiconductive materials. In general, such materials that are “potentially insulating” in the meaning of the invention are less conductive than metals.

In the closed position, the contact members 3, 4 thus form the electrodes of the spark gap E, and the protection device 1 of the invention then combines a function of protecting from voltage surges via the spark gap E, and a function of protecting from current surges, via the moving contact member 3. The spark gap E thus forms a protection element for protecting from voltage surges, disposed physically between the contact members 3, 4 and electrically connected, in the closed position, to the electrical installation 2 so as to protect it from voltage surges.

The moving contact member 3 is advantageously mounted such that, when in the closed position, it comes into abutment against the potentially insulating piece 15.

In a first variant embodiment of the invention, the potentially insulating piece 15 is made of a dielectric material, e.g. of ceramic.

In a second variant embodiment of the invention, the piece 15 is made of a semiconductive material, and it advantageously constitutes a varistor. The protection device 1 then constitutes a protection device having two stages, namely a fine protection stage and a coarse protection stage. Thus, in the event of low-power voltage surges, for which the varistor does not reach its maximum current-passing capacity, the voltage surge current passes through the varistor, which then forms a conductive bridge between the contact members 3, 4 and protects the electrical installation 2. Conversely, when a high-power voltage surge occurs, for which the current-passing capacity of the varistor is exceeded, an electric arc 16 is struck between the contact members 3, 4 and bypasses the varistor, the spark gap E then forming the protection element for protecting the electrical installation 2.

Advantageously, when they are in the closed position, the contact members 3, 4 are separated by the dielectric medium 17 which is preferably constituted by a fluid and formed by a gas such as air, and the piece 15 is disposed between the contact members 3, 4 so that, in the event of a voltage surge exceeding a predetermined value, an electric arc 16 is struck in the dielectric medium 17, substantially at the interface with the piece 15. The electric arc 16 is thus struck advantageously along the piece 15, the zone that is situated in the dielectric medium 17, in the vicinity of said piece 15, then constituting the arc-striking zone of the spark gap E.

The potentially insulating piece 15 thus advantageously forms an auxiliary trigger for triggering the spark gap E, making it possible to improve control over triggering thereof, and thus to improve control over the level of protection offered by the protection device 1. The piece 15 makes it possible, in particular, to avoid having to use a more complex trigger system, such as a trigger circuit, which, in order to be incorporated into a known protection device, would require the structure to be modified profoundly and would also lead to an increase in the overall size of the device.

Advantageously, the protection device 1 of the invention includes an interrupter device 18 for interrupting the electric arc 16. Conventionally, the interrupter device 18 is formed by an arrangement of metal plates 19 mounted in parallel and suitable for splitting the electric arc 16 coming from the spark gap E into a plurality of arc elements in a manner such as to cause it to be extinguished. The interrupter device 18 is advantageously disposed at the outlet of the air gap E, i.e. at the ends of the contact members 3, 4 that are remote from the arc-striking zone. The interrupter device 18 and the contact members 3, 4 are thus disposed relative to one another in a manner such that when the contact members 3, 4 open, the electric arc 16 is driven towards the interrupter device 18.

In order to improve the compactness of the protection device 1 further, the interrupter device 18, and in particular the splitting metal plates 19 extend preferably in a direction X-X′ that is substantially perpendicular to the longitudinal direction Y-Y′ in which the contact members 3, 4 extend.

In a preferred variant of the invention, the protection device 1 of the invention is incorporated into a housing that is in the form of a cartridge (not shown) suitable for being plugged into a base (not shown). This variant embodiment thus facilitates maintenance and in particular replacement of the device.

The protection device 1 of the invention also preferably includes indication means (not shown) for indicating the state of the device. Said indication means are, in particular, suitable for warning third parties, by means, for example, of suitable visual information, that the protection device 1 is out of service and disconnected from the electrical installation 2. Such indication means are advantageously connected functionally, and preferably mechanically, to the moving contact member 3 so that the moving contact member 3 moving from its closed position to its open position actuates the indication means for indicating the state of the protection device 1.

The present invention also relates to a method of manufacturing a protection device 1 for protecting an electrical installation, the protection device 1 including at least two electrically conductive contact members 3, 4 that are suitable for going from a closed position to an open position when a current I of magnitude greater than a predetermined threshold value passes through the protection device 1, the method including a mounting step consisting in mounting a potentially insulating piece between the contract members 3, 4, so that, when they are in the closed position, the contact members 3, 4 are separated by said potentially insulating piece 15, thereby forming a spark gap for protecting from voltage surges between the contact members 3, 4.

The mounting step (a) thus advantageously includes a separation stage for separating the contact member 3, 4, and during which the potentially insulating piece 15 is positioned between the contact members 3, 4, so as to hold them apart when they are in the closed position.

Before the mounting step (a), the protection device 1 can thus be formed by a pre-existing protection device, of the circuit-breaker type, for protecting from current surges, which device is transformed into a protection device, of the lightning arrester type, for protecting from voltage surges, merely by interposing the potentially insulating piece 15 between the contact members 3, 4. The mounting step (a) then consists in modifying the protection device for protecting from current surges so as to transform it into a protection device for protecting from voltage surges. Such a method makes it possible to improve the functionality of the protection device for protecting from current surges, without modifying it fundamentally. It is thus possible, by means of the method of the invention, to modify current surge protection devices of the circuit-breaker type that are already in place in electrical installations or equipment, so as to impart to them an additional function of protecting from voltage surges. The method of the invention thus makes it possible to avoid costly replacement of devices that are already in place.

The present invention also relates to the use of a potentially insulating piece for forming a spark gap E for protecting from voltage surges between the separable contact members of a protection device for protecting against current surges. For this purpose, the potentially insulating piece 15 is advantageously interposed between the contact members 3, 4.

The present invention also relates to the use of a current surge protection device 1 of the circuit-breaker type as a protection device for protecting against voltage surges, in which use a potentially insulating piece 15 is interposed between the contact members 3, 4 of the current surge protection device so as to form a spark gap E for protecting from voltage surges between said contact members 3, 4.

Operation of the protection device 1 of the invention is described below with reference to FIGS. 1 to 4.

The protection device 1 is initially in its service configuration shown in FIG. 3. When a voltage surge occurs, exceeding the maximum current-passing capacity of the potentially insulating piece 15, an electric arc 16 is struck along the piece 15 in the air between the contact members 3, 4. The electric arc 16 then passes the current I corresponding to the voltage surge, e.g. to ground, and thus protects the electrical installation 2 by diverting that current. When the current I to be passed exceeds a predetermined threshold at which it might damage the protection device 1, and in particular the spark gap E, the detector means 6, which are sensitive to such a current surge, trigger the drive mechanism 12 which acts on the moving contact member 3 in a manner such as to put it into motion under resilient bias towards its open position. In said open position, the contact members 3, 4 are separated by an isolation distance d that is sufficient to prevent an electric arc from being sustained and from re-striking.

As the contact members 3, 4 open, the electric arc 16 that was struck initially is then driven towards the outlet of the spark gap 3 and towards the interrupter device 18, which is advantageously formed by a splitter chamber. The V-shaped configuration of the contact members 3, 4 as they open then contributes to driving the electric arc 16 more rapidly towards the interrupter device 18. By being split in the interrupter device 18, the electric arc 16 is extinguished, and the protection device 1 is then irreversibly disconnected from the remainder of the electrical installation 2 and must be replaced. Indication means of the visual type then inform the operator that the protection device 1 is defective and that the necessary steps should be taken quickly to replace it.

The protection device 1 of the invention thus constitutes a lightning arrester with an integrated circuit-breaker that, in order to be implemented, requires only simple and small modification of a conventional circuit-breaker.

Another advantage of the protection device 1 of the invention is that the fact that it is implemented as a one-piece unit limits the risk of error in choosing the type of circuit-breaker to be associated with any given lightning arrester.

Another advantage of the invention is that it brings together, in a single unit, two different functions, namely voltage surge protection and current surge protection.

The present invention may be used in manufacturing protection devices for protecting electrical equipment and electrical installations.

1. A protection device for protecting an electrical installation, which protection device is designed to be connected in parallel with the electrical installation and includes at least two electrically conductive contact members that are suitable for going from a closed position to an open position when a current of magnitude greater than a predetermined threshold value passes through the protection device, wherein said protection device, when in the closed position, has the contact members separated from each other by a potentially insulating piece, thereby forming a spark gap for protecting from voltage surges between the contact members.

2. The device of claim 1, wherein the contact members, when in the closed position, are in physical contact with the potentially insulating piece.

3. The device of claim 1, wherein the contact members, when in the closed position, are held apart from each other by the potentially insulating piece.

4. The device of claim 1, wherein the device includes at least one moving contact member suitable for moving between the closed position and the open position.

5. The device of claim 4, wherein the moving contact member is mounted in a manner such that, in the closed position, the moving contact member comes into abutment against the potentially insulating piece.

6. The device of claim 1, wherein the contact members, when in the closed position, are situated at a distance apart such that, in the event of a voltage surge, an electric arc is struck between said contact members, thereby passing the voltage surge current.

7. The device of claim 1, wherein, when the current exceeds the predetermined threshold value, the contact members move apart towards their open position, thereby making it possible to interrupt the current.

8. The device of claim 1, wherein the potentially insulating piece is made of a dielectric material.

9. The device of claim 1, wherein the potentially insulating piece is made of a semiconductive material.

10. The device of claim 9, wherein the potentially insulating piece is a varistor.

11. The device of claim 1, wherein the contact members, when in the closed position, are also separated by a fluid dielectric medium the potentially insulating piece being disposed between the contact members so that, in the event of a voltage surge, an electric arc is struck in the fluid dielectric medium, substantially at the interface with the potentially insulating piece.

12. The device of claim 1, further comprising an electric arc interrupter device.

13. The device of claim 12, wherein the interrupter device and the contact members are disposed relative to one another such that, as the contact members open, the electric arc is driven towards the interrupter device.

14. The device of claim 1, wherein the device is incorporated in a plug-in cartridge.

15. The device of claim 1, further comprising indication means for indicating the state of the protection device.

16. The device of claim 15, wherein the indication means are actuated by the movement of the moving contact member.

17. A lightning arrester with an integrated circuit-breaker comprising a protection device for protecting an electrical installation, which protection device is designed to be connected in parallel with the electrical installation and includes at least two electrically conductive contact members that are suitable for going from a closed position to an open position when a current of magnitude greater than a predetermined threshold value passes through the protection device, wherein said protection device, when in the closed position, has the contact members separated from each other by a potentially insulating piece, thereby forming a spark gap for protecting from voltage surges between the contact members.

18. A method of manufacturing a protection device for protecting an electrical installation, which protection device includes at least two electrically conductive contact members that are suitable for going from a closed position to an open position when a current of magnitude greater than a predetermined threshold value passes through the protection device, said method comprising: (a) mounting a potentially insulating piece between the contact members, so that, in the closed position, the contact members are separated from each other by said potentially insulating piece, thereby forming a spark gap for protecting from voltage surges between the contact members.

19. The method of claim 18, wherein the mounting step (a) is implemented in a pre-existing protection device for protecting against current surges.

20. A method of using a current surge protection device as a protection device for protecting from voltage surges, comprising: interposing a potentially insulating piece between the contact members of the current surge protection device so as to form a spark gap for protecting from voltage surges between said contact members.
